(19) United States
(12) Patent Application Publication
(10) Pub. No.: US 2016/0167059 A1
(43) Pub. Date: Jun. 16, 2016

(54) WALL PLUG-IN ION GENERATOR DEVICE

(71) Applicant: Charles Houston WADDELL, Roanoke, VA (US)

(72) Inventor: Charles Houston WADDELL, Roanoke, VA (US)

(21) Appl. No.: 14/885,070

(22) Filed: Oct. 16, 2015

Related U.S. Application Data
(60) Provisional application No. 62/064,563, filed on Oct. 16, 2014.

(51) Int. Cl. B03C 3/66; B03C 3/155; B03C 3/04

(52) U.S. Cl. CPC B03C 3/66; B03C 3/04; B03C 3/155

(57) ABSTRACT

The present invention provides methods and systems for a wall plug-in ion generator device that includes a base, a housing selectively secured to the base, at least one electrode for generating ions, a fan disposed within the housing, and a power supply for providing voltage to the at least one electrode for producing ions.

### FIELD OF THE INVENTION

The present invention relates generally to an ion generator device for individual residential or recreational use, and more generally relates to a wall plug-in generator device that ionizes air for individual residential or recreational use.

### BACKGROUND OF THE INVENTION

Air and other fluids are commonly treated and delivered for a variety of applications. For example, in heating, ventilation and air-conditioning (HVAC) applications, air may be heated, cooled, humidified, dehumidified, filtered or otherwise treated for delivery into residential, commercial or other spaces.

Needs exist for improved systems and methods of treating and delivering air for these and other applications, especially in residential or recreational living areas. It is to the provision of improved systems and methods meeting these needs that the present invention is primarily directed.

### BRIEF SUMMARY OF THE INVENTION

According to an embodiment of the present invention, a wall plug-in ion generator device that includes a base, a housing selectively secured to the base, at least one electrode for generating ions, a fan disposed within the housing, and a power supply for providing voltage to the at least one electrode for producing ions.

According to yet another embodiment of the present invention, the wall plug-in ion generator device that includes a base that has a vertical portion and a horizontal portion, the horizontal portion contains an opening for allowing air to flow within the device.

According to yet another embodiment of the present invention, the wall plug-in ion generator device includes at least two prongs positioned on the base for engaging an electrical connector.

According to yet another embodiment of the present invention, the wall plug-in ion generator device includes a filter media disposed in close proximity to the opening.

According to yet another embodiment of the present invention, the wall plug-in ion generator device includes a fan positioned within the housing.

According to yet another embodiment of the present invention, the wall plug-in ion generator device includes two electrodes.

According to yet another embodiment of the present invention, the wall plug-in ion generator device includes a plurality of holes on the housing.

According to yet another embodiment of the present invention, the wall plug-in ion generator device includes a housing, at least one electrode for generating ions positioned within the housing, a fan disposed within the housing, and a power supply for providing voltage to the at least one electrode for producing ions.

According to yet another embodiment of the present invention, a method of producing ions that includes providing an ion generator device with a base, a front side, a back side, and at least one electrode and engaging the device to an electrical connector.

According to yet another embodiment of the present invention, the method of producing ions includes allowing voltage to flow through the power supply and to the at least one electrode for producing ions.

### BRIEF DESCRIPTION OF THE DRAWINGS

The present invention is illustrated and described herein with reference to the various drawings, in which like reference numbers denote like method steps and/or system components, respectively, and in which:

FIG. 1 is a side view of an exemplary embodiment of the device;

FIG. 2 is a front view of an exemplary embodiment of the device;

FIG. 3 is a top view of an exemplary embodiment of the device;

FIG. 4 is a back view of an exemplary embodiment of the device;

FIG. 5 is a side view of an exemplary embodiment of the vertical portion of the base of the device;

FIG. 6 is a bottom view of the horizontal portion of the base of the device;

FIG. 7 is a side view of the horizontal portion of the base of the device;

FIG. 8 is a top view of the fan of the device;

FIG. 9 is a side view of the fan;

FIG. 10 is a top perspective view of a circuit board contained within the device; and

FIG. 11 is an exemplary circuit diagram.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

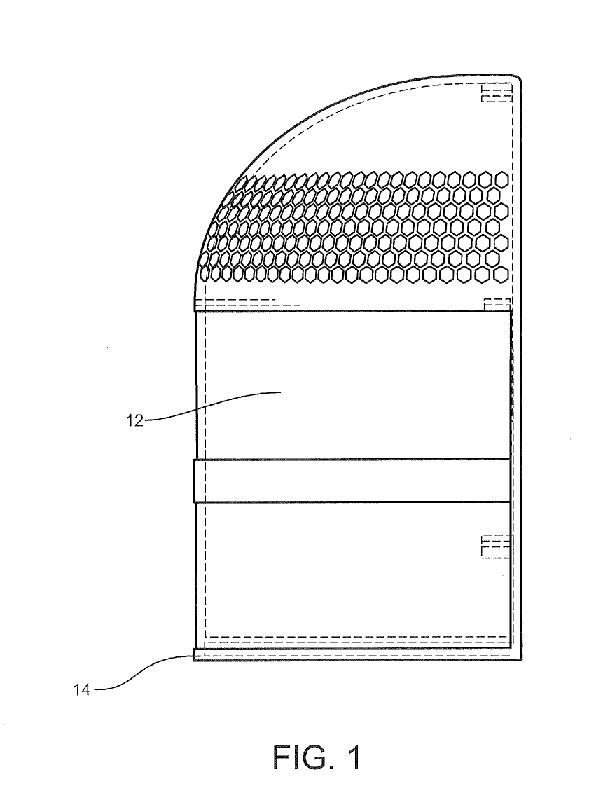

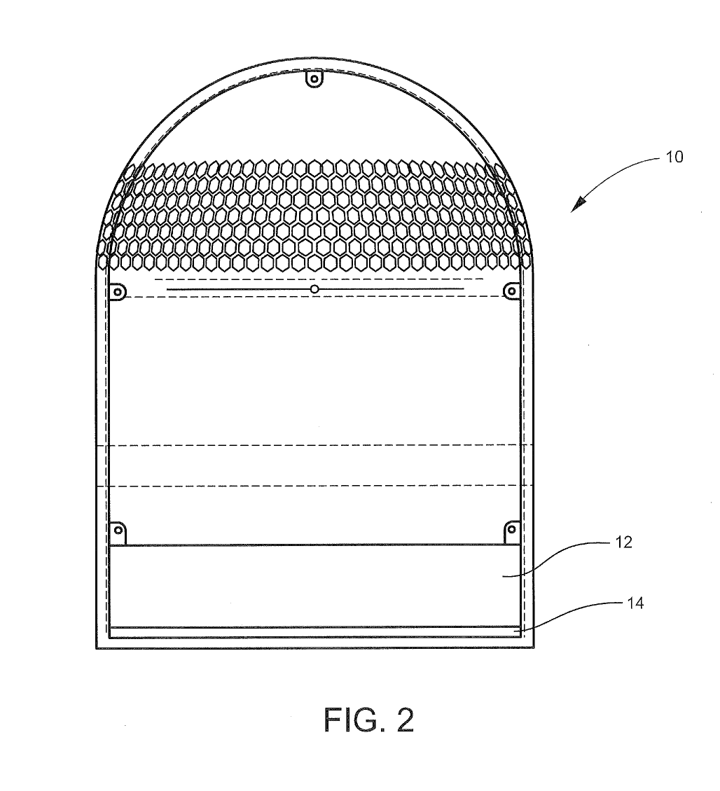

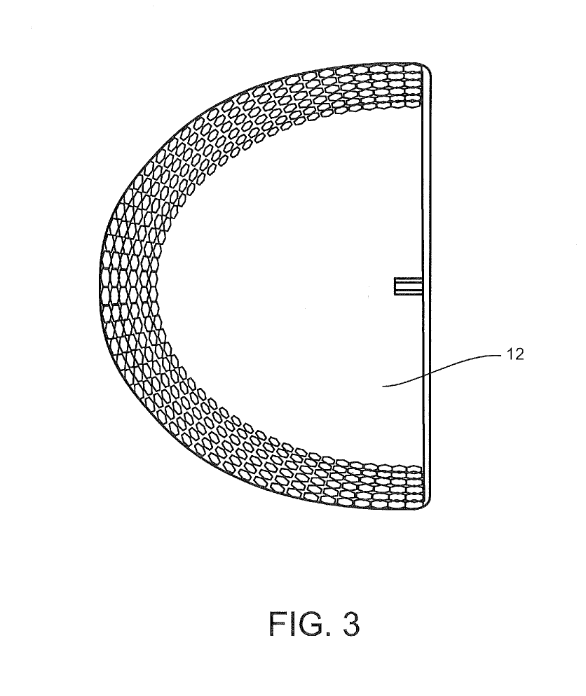

Referring now specifically to the drawings, a wall plug-in ion generator device is illustrated in FIG. 1 and is shown generally at reference numeral 10. The device has an outer housing 12 with a base 14, as shown in FIGS. 1-3. The base 14 contains a vertical portion with a top end and a bottom end. A horizontal portion extends outwardly from the bottom end of the vertical portion. The housing 12 is engaged or selectively secured to the base 14. The housing 12 contains a front portion, a back portion, and a bottom portion, wherein the front portion is substantially curved. The back portion is relatively straight for engagement or being selectively secured to the vertical portion of the base 14. The bottom portion of the housing 12 is relatively flat for engagement or being selectively secured to the horizontal portion of the housing 12. The vertical portion of the base 14 is designed for placement against a wall or the like.

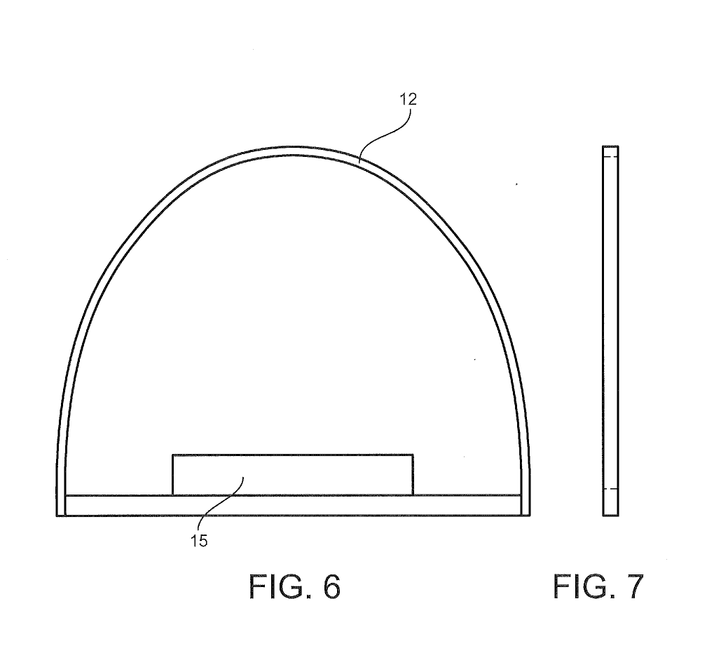

The housing 12 extends generally outwardly from the outer sides of the vertical portion of the base 14 in an arcuate fashion, as shown in FIG. 6. The housing 12 is substantially curved. The top portion of the housing 12 is frustoconically shaped with a plurality of holes 11 disposed for allowing ionized air to exit the device 10.

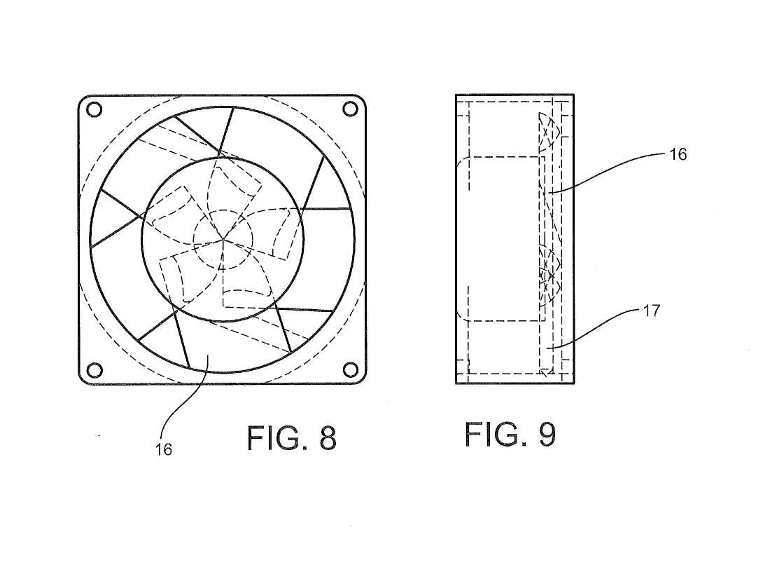

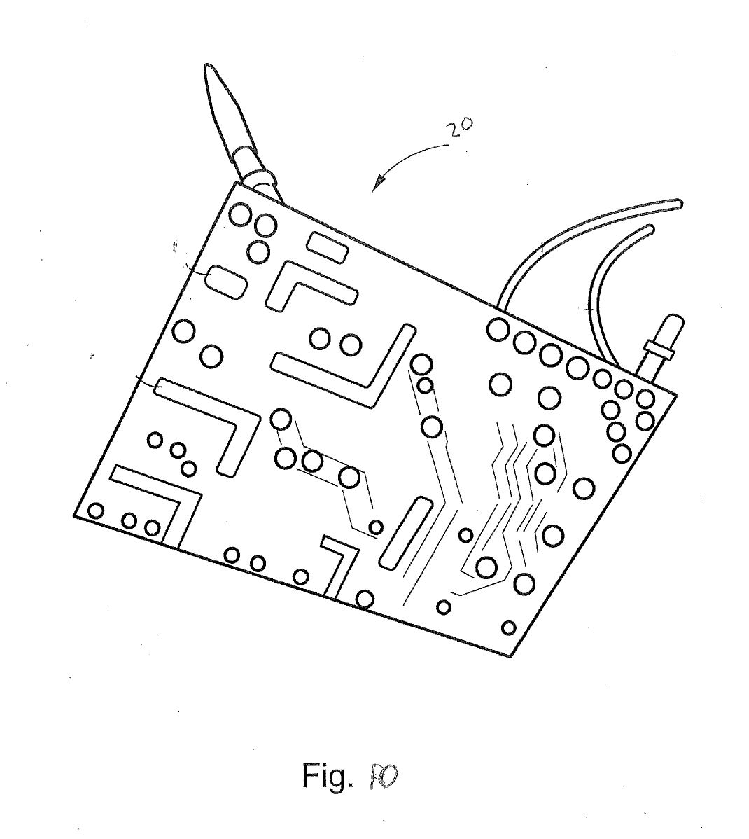

The device 10 contains an opening 15 for allowing air to penetrate the device 10, as shown in FIG. 6. The opening may be located within the base 14 of the device 10 for allowing the air to flow through the base 14. As illustrated in FIGS. 7 and 8, a fan 16 is positioned in the device 10 for pushing air through the device 10 and into the livable space around the device 10. The fan 16 may pull air through the opening 15 and into the device 10, where it is itemized and the air is then pushed out of the device 10 through the holes 11. In other words, the fan 16 sucks air into the device through the opening 15. The air is then ionized within the device 10 and pushed out through the openings.

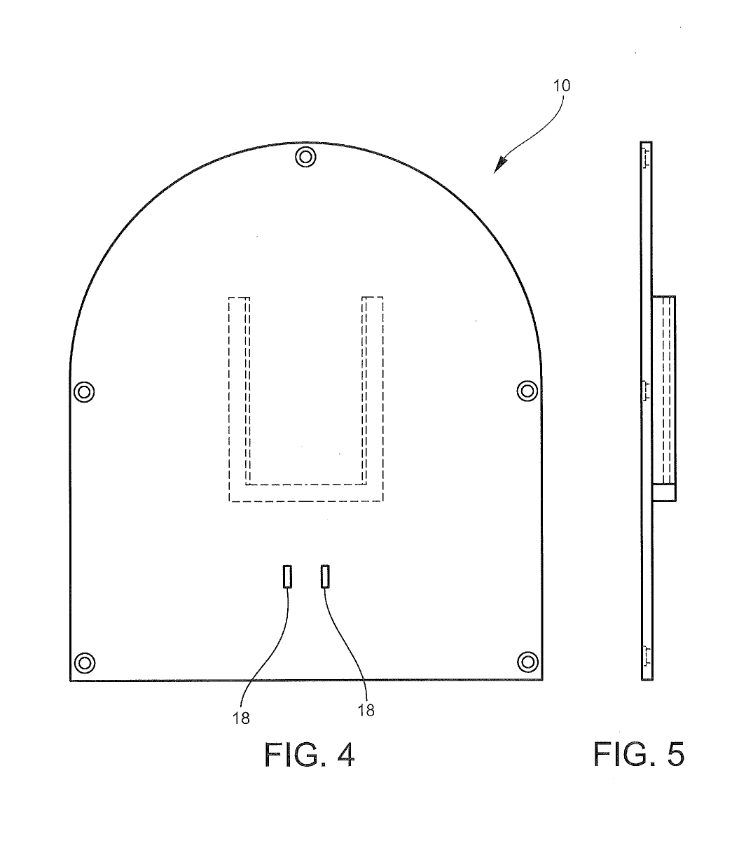

As illustrated in FIG. 4, at least two prongs 18 are disposed on the device 10 for engaging to an electrical connector and supplying power to the device 10 for powering the fan 16. The device 10 may also contain three prongs 18, with one prong grounding the device 10. A filter media 17 is also disposed adjacent the opening for filtering the air entering the device 10.

The base 14 of the housing 12 may be selectively secured to the housing 12 for allowing a different housing 12 to be engaged to the base 14.

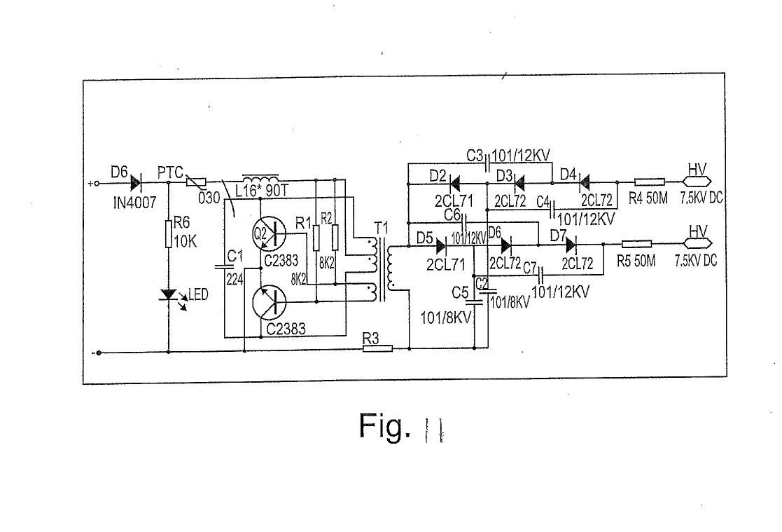

A circuit board 20, as illustrated in FIG. 10, may be contained within the device 10, having a circuit diagram as shown in FIG. 11. The circuit board 20 is not continuous and has air gaps contained therein. The purpose of the air gaps is to prevent the high voltage from jumping to the low voltage area, and preventing the low voltage from jumping to the high voltage area. The circuit board 20 includes a power supply source, a transformer, and a first high voltage wire 22, and a second high voltage wire 24. The first high voltage wire 22 and second high voltage wire 24 produce the ions used in the device 10. Alternatively, electrodes, that serve the same function as the first high voltage wire 22 and second high voltage wire 24 may be disposed on the electrode for producing ions.

The device 10 preferably produces approximately equal amounts of positive ions and negative ions, regardless of airflow velocity or other conditions such as humidity or temperature. In example forms, the device 10 produces positive ions and negative ions in a concentration of at least about 10⁹ ions/second. In alternate embodiments, the device generates negative ions only, or positive ions only, or generates negative ions and positive ions in unequal quantities. The device 10 optionally utilizes nano-electronic components allowing the device to be very compact, requiring less than 1 watt/ion generator module, for example less than 0.5 watts/ion module, and in further examples less than 0.36 watts per ion module.

The device 10 may include two electrodes ⁺ and ⁻ within the housing 12 that are aligned generally perpendicularly to the direction of the airflow generated by the fan 16, to prevent recombination of the positively charged ions with the negatively charged ions. Alternatively, the electrodes may only produce + electrons or − electrons.

The treatment of air by delivery of ionization to an airflow within a residential or recreational living space according to the systems and methods of the present invention may be utilized for various purposes. For example, application of ionization to air may be utilized to abate allergens, pathogens, odors, gases, volatile organic compounds, bacteria, virus, mold, dander, fungus, dust mites, animal and smoke odors, and/or static electricity in a treated air space to which the airflow is directed. Ionization of air in living and working spaces may reduce building related illness and improve indoor air quality; and additionally can reduce the quantity of outside air needed to be mixed with the treated indoor air, reducing heating and cooling costs by enabling a greater degree of air recirculation.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A wall plug-in ion generator device, comprising:
a base;
a housing selectively secured to the base;
at least one electrode for generating ions;
a fan disposed within the housing; and
a power supply for providing voltage to the at least one electrode for producing ions.

2. The wall plug-in ion generator device of claim 1, wherein the base has a vertical portion and a horizontal portion, the horizontal portion contains an opening for allowing air to flow within the device.

3. The wall plug-in ion generator of claim 1, further comprising at least two prongs positioned on the base for engaging an electrical connector.

4. The wall plug-in ion generator of claim 1, further comprising a filter media disposed in close proximity to the opening.

5. The wall plug-in ion generator of claim 1, further comprising a fan positioned within the housing.

6. The wall plug-in generator of claim 1, further comprising two electrodes.

7. The wall plug-in generator of claim 1, further a plurality of holes on the housing.

8. A wall plug-in ion generator device, comprising:
a housing;
at least one electrode for generating ions positioned within the housing;
a fan disposed within the housing; and
a power supply for providing voltage to the at least one electrode for producing ions.

9. The wall plug-in ion generator device of claim 8, wherein the base has a vertical portion and a horizontal portion, the horizontal portion contains an opening for allowing air to flow within the device.

10. The wall plug-in ion generator of claim 8, further comprising at least two prongs positioned on the base for engaging an electrical connector.

11. The wall plug-in ion generator of claim 8, further comprising a filter media disposed in close proximity to the opening.

12. The wall plug-in ion generator of claim 8, further comprising a fan positioned within the housing.

13. The wall plug-in generator of claim 8, further comprising two electrodes.

14. The wall plug-in generator of claim 8, further a plurality of holes on the housing.

15. A method of producing ions, comprising:
providing an a housing, at least one electrode for generating ions positioned within the housing, a fan disposed within the housing, and a power supply for providing voltage to the at least one electrode for producing ions.
engaging the device to an electrical connector.

16. The method of producing ions according to claim 15, further comprising allowing voltage to flow through the power supply and to the at least one electrode for producing ions.

17. The method of producing ions according to claim 15, further providing an opening within the housing.

18. The method of producing ions according to claim 15, further providing a filter media disposed within the housing.

19. The method of producing ions according to claim 15, further providing a plurality of openings on the housing.

20. The method of producing ions according to claim 15, further comprising providing a circuit board within the housing.
